(19) United States
(12) Patent Application Publication
(10) Pub. No.: US 2006/0178835 A1
(43) Pub. Date: Aug. 10, 2006

(54) Normalization methods for genotyping analysis

(75) Inventor: Jeffrey A. Marks, Mountain View, CA (US)

Correspondence Address: MILA KASAN, PATENT DEPT.;APPLIED BIOSYSTEMS, 850 LINCOLN CENTRE DRIVE, FOSTER CITY, CA, 94404, US

(73) Assignee: Applera Corporation, Foster City, CA (US)

(21) Appl. No.: 11/057,321

(22) Filed: Feb. 10, 2005

(51) Int. Cl. G06F 19/00

(52) U.S. Cl. 702/19; 702/20

(57) ABSTRACT

In arrays and other high density analysis platforms variabilities between data points and/or data sets may arise for a number of reasons. Disclosed are methods for addressing these variabilities and generating correction factors that may be used in conforming the data to expected or desired distributions. The methods may be adapted to operate with existing data analysis approaches and software applications to improve downstream analysis.

### FIELD

The present teachings generally relate to the field of genetic analysis and more particularly to methods for normalization of genotyping data.

### INTRODUCTION

High density analysis platforms such as oligonucleotide microarrays and multiplexed PCR assays are widely used in the study of complex biological samples. These technologies have been adapted for use in experiments wherein large numbers of genes or proteins from multiple samples are compared and/or evaluated. Additionally, these technologies have found application in a variety of areas including: expression profiling, sequencing, mutational analysis, genotyping, and organism/disease identification. In general, fluorescent, radioactive, or chemiluminescent labels/tags are used as a mechanism for detection and quantitation on the basis of observed signal intensities. While, many hundreds, if not thousands, of different targets can be simultaneously evaluated in this manner, data resolution and analysis is frequently confounded by sample-to-sample variations including non-linear spectral shifts. This problem is particularly apparent when attempting to compare data across multiple samples or experiments. Conventional normalization and scaling methods that adjust raw data so that it may be used in comparative analysis frequently introduce undesirable errors or biases that reduce quantitative accuracy and diminish overall results confidence. Consequently there is a need for an improved method by which signal/intensity data can be assessed, corrected and compared.

### SUMMARY

In various embodiments the present teachings describe methods for identifying and accounting for variabilities/deviations between data sets. These methods implement numerical approaches to analyze the relationship between one or more series/collections of data points (for example, signal or intensity data from a microarray or multiplex-PCR assay). These processes may be applied to array-based data or multi-component analyses to facilitate the comparison and processing of data arising from two or more sample sets. Correction factors are developed and used in the normalization of the data sets with respect to one another to facilitate comparative analysis. This approach provides a relatively straightforward and efficient mechanism to assess and correlate data. Furthermore, the disclosed methods may increase quantitative accuracy and improve overall confidence in the analysis.

In certain embodiments, the disclosed methods may be directed towards the evaluation of genotyping data. Data processing in this context may involve performing analyses across multiple data sets grouped into one or more clusters wherein the standard deviation between data of the clusters includes variabilities such as non-linear spectral shifts. The observed variabilities may be expressed as angular values and graphically represented. The methods described herein do not necessarily require control sample information to conduct the normalization process allowing this information to be used in other ways such as in assessing assay performance. This approach may be desirable as control sample information can be retained to independently verify the accuracy of the correction factors. Furthermore, the disclosed methods may be readily adapted for use with or incorporated into new and existing data analysis software to perform data normalization in an automated manner.

In various embodiments, a method for evaluating information during biological analysis is disclosed. This method comprises: identifying a data collection comprising a plurality of signal values associated with at least one sample; providing a common representation of the signal values and determining a sorting criteria that is applied to the common representation of the signal values; determining an expected distribution of the signal values; and determining at least one correction factor applied to at least one of the plurality of signal values so as to conform the at least one signal value to the expected distribution.

In still other embodiments, a system for evaluating information during biological analysis is disclosed. The system comprises: a data collection component the provides functionality for identifying a data collection comprising a plurality of signal values associated with at least one sample; a computational component that provides functionality for generating a common representation of the signal values, determining a sorting criteria that is applied to the common representation of the signal values and determining an expected distribution of the signal values; and an analysis component that provided functionality for determining at least one correction factor applied to at least one of the plurality of signal values so as to conform the at least one signal value to the expected distribution.

In other embodiments, an apparatus comprising a computer readable medium having instructions stored thereon to analyze nucleotide sequence information is disclosed. The analysis comprises conducting the steps of: identifying a data collection comprising a plurality of signal values associated with at least one sample; providing a common representation of the signal values and determining a sorting criteria that is applied to the common representation of the signal values; determining an expected distribution of the signal values; and determining at least one correction factor applied to at least one of the plurality of signal values so as to conform the at least one signal value to the expected distribution.

In still other embodiments, a method for genetic analysis is disclosed. This method comprises: identifying a sample set comprising a plurality of signal values associated with a plurality of sample species; generating angular measurements corresponding to the plurality of signal values for the sample set; sorting the angular measurements for each of the sample species; calculating a mean angle for the sorted angular measurements for each of the sample species; determining a polynomial fit for each mean angle versus a calculated percentile for that mean angle in relation to mean angles for other sample species of the sample set; calculating an expected angular distribution for the plurality of signal values associated with a selected sample species; calculating a polynomial fit for the sorted angular measurements for the selected sample species versus the expected angular distribution to identify at least one correction factor for the angular measurements; and applying the correction factor to the angular measurements associated with a selected sample species to conform the distribution of angles to the expected distribution.

### BRIEF DESCRIPTION OF FIGURES

FIGS. 1 A-B illustrate the properties and effects of spectral shifting in exemplary data sets.

FIG. 1C illustrates an exemplary scatterplot in which angular values are determined and used to aid in allelic identification.

FIG. 2 illustrates an overview method for determining correction factors to account for spectral shifts between data sets.

FIG. 3 illustrates one embodiment of a method for determining correction factors to account for spectral shifts between data sets.

FIGS. 4 A-B graphically illustrate the exemplary application of correction factors to account for spectral shifts within a data set.

FIG. 5 illustrates a block diagram of a system for conducting an analysis according to the present teachings.

FIGS. 6 A-B illustrate exemplary results for allele calls of an exemplary SNP data set before and after the application of the normalization methods of the present teachings.

### DESCRIPTION OF VARIOUS EMBODIMENTS

Reference will now be made to various embodiments, examples of which are illustrated in the accompanying drawings.

The present teachings describe a system and methods for implementing data normalization and/or signal correction techniques that may be configured for use with genotyping analysis procedures including by way of example allele analysis and single nucleotide polymorphism (SNP) analysis. Additionally, the methods may be used with a variety of different data sets including those associated with analytical platforms generating signals by fluorescent labels, radioactive labels and/or chemiluminescent labels. In various embodiments, the data operated upon by these methods comprises intensity/signal information acquired by a data acquisition instrument which is used to determine the presence and/or concentration of selected target molecules contained within one or more samples. In one particular embodiment, the method may be used to correct for shifts in spectral properties or variations encountered in high multiplex fluorescent genotyping assays. The disclosed data analysis approaches may further be adapted to be operated in a substantially automated manner and may be integrated with existing software-based solutions used for target quantitation and/or evaluation.

To illustrate the functional details of the present teachings, the methods are described in the context of analyzing signal data relating to identification of single nucleotide polymorphisms used in genotyping and mutational analysis. It will be appreciated, however, that these methods may be adapted to other analytical paradigms involving data associated with organism/disease identification, sequence determination, nucleotide/protein quantitation, and others.

As used herein, the term microarray encompasses a broad range of different technologies which may include for example; synthetic oligonucleotide-based arrays (e.g. GeneChip® Arrays produced by Affymetrix Inc.), fiber-bundle bead arrays/randomly assembled arrays (e.g. BeadArrays™ produced by Illumina Inc.), slide arrays, spotted arrays (e.g. chemiluminescent microarrays produced by Applied Biosystems Inc.), and other technologies and products based upon signal detection (e.g. fluorescence, chemiluminescent, radioactive, or other labels) used as a mechanism to identify and resolve target molecules.

The disclosed methods may be adapted for use with the aforementioned microarray platforms and other technologies in which signals are acquired for a plurality of samples that are to be desirably normalized and evaluated including for example: PCR-based applications, including real-time quantitative analysis, such as those based on Taqman® or SNPlex® chemistries. Consequently, it will be appreciated that the samples and resulting data need not be limited to those associated with microarray platforms and may for example, originate from multiplexed reactions, multi-well microtiter plates, and other sources were a plurality of sample data sets are to be desirably evaluated in connection with or compared to one another. The disclosed methods are conceived to be operable in these and other contexts and not necessarily limited in scope to any particular platform or signal-based analytical technology.

In one aspect, the present teachings provide a mechanism to account for sample-to-sample variabilities and provide a normalization approach using an analysis method which evaluates the relationship between a series of acquired signals or data points. Unlike many conventional methods which attempt to account for such variability's using known standards or controls to develop correction factors, the operation of the methods described herein are not necessarily dependent on internal controls. Such control independence may be desirable for a number of reasons including: increasing the availability of controls for assay validation and providing improved normalization or comparative capabilities for unknown samples or samples lacking controls or internal standards.

When performing array-based/multiplex analysis or analysis involving a plurality of samples, sample to sample variability is often observed, wherein the detected signals between samples are desirably normalized so as to facilitate meaningful comparison of the acquired data. For example, when performing a multiplex SNP (Single Nucleotide Polymorphism) assay, a thousand or more SNP calls or identifications may be associated with an experimental sample data set. Comprehensive SNP analysis may proceed across multiple data sets or experiments wherein non-random or systematic deviations between the acquired signals associated with each data set are observed. These deviations may result from a number of different factors including platform variabilities (e.g. manufacturing, preparation, processing), sample variabilities (e.g. preparation, concentration, composition), systematic variabilities (e.g. detection differences, cross-instrument differences, environmental differences), and other sources of variability that result in differences in the signal characteristics or increases in standard deviations between the sample data sets. Such occurrences may present potential difficulties when attempting to relate the data from one data set to the next. Other factors which may contribute to data set variabilities include but are not limited to instrument/signal detector movements or shifts, focus or optical alignment variability, cross-hybridization within one or more selected samples, non-specific binding of target or analyte, lack of specificity in the analysis procedure, biases in sample amplification and/or label incorporation, label or dye degradation, and the presence of sample impurities or reactant side-products.

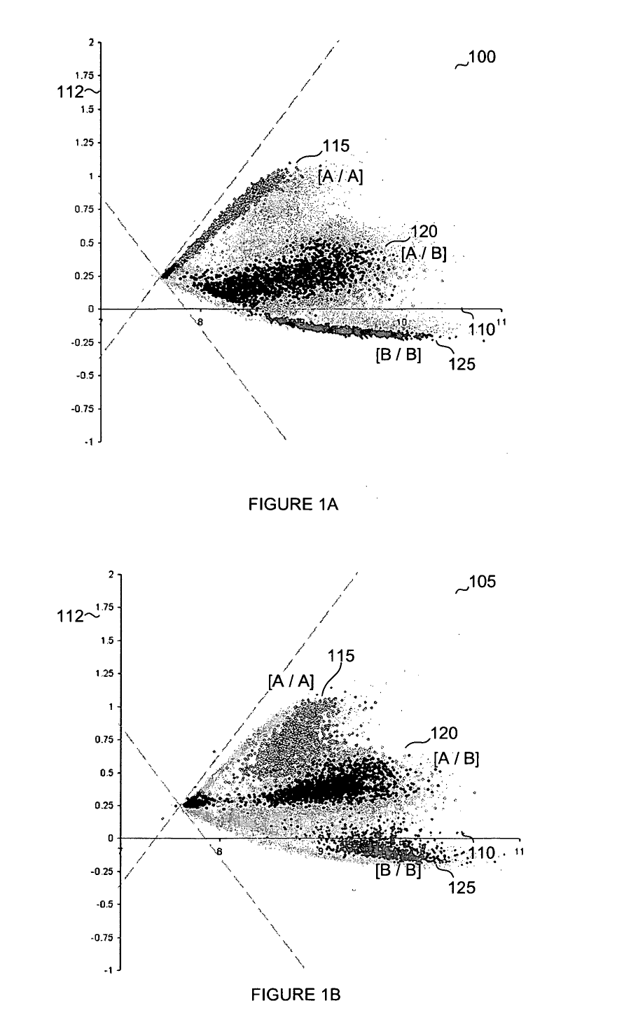

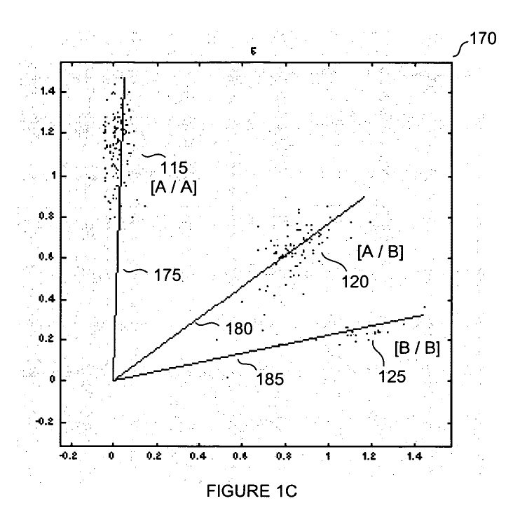

FIGS. 1A, B illustrate two exemplary data sets 100, 105 in which variations arising from spectral shifting are observed. Each data set 100, 105 may be representative of a plurality of data points obtained for example from an allele-identification analysis (in this case using known samples) wherein the data points are desirably classified according to their composition. In one aspect, the allelic classification comprises determining if a sample is homozygous or heterozygous in nature. An exemplary classification may be determined according to observed signals using known methods in which probes or labels are integrated into a sample and wherein each probe comprises a discrete marker or reporter dye specific for a different allele. Differential labeling of each sample according to its composition is accomplished by integration of a probe specific for a selected allele into the sample according to the sample's allelic composition. The signal-generating properties of the resulting sample product may then be evaluated to determine if the sample is homozygous for a first allele (e.g. A/A), homozygous for a second allele (e.g. B/B), or a heterozygous allelic combination (e.g. A/B).

Allelic discrimination as described above may be implemented using various multiplex analysis products. Further details of the chemistries and compositions related to each may be found in commercial product literature/manuals. In one exemplary analytical paradigm homozygous samples tend to exhibit an increased signal or intensity associated with one or another label. A signal associated with the opposing label (e.g. other allelic component) is significantly diminished or completely absent. Conversely, a sample heterozygous composition (e.g. having two or more alleles) may exhibit a substantial signal arising from both labels. A commercial implementation of this method is Applied Biosystems' Taqman® platform, which employs Applied Biosystems' Prism 7700 and 7900HT sequence detection systems to monitor and record the fluorescence for amplified samples containing labels associated with specific allelic compositions. Similarly, another example of an analytical method which may involve the generation and interpretation of signal data associated with genotyping or SNP analysis is a high multiplex array-based assay. Commercial implementations of these methods may be based on a fiber bundle array or an oligonucleotide array. In such implementations, labeled sample molecules hybridize to coated beads or selected positions (e.g. features) of a microarray through complimentary binding between nucleotide, peptide, or protein species. Subsequently, the signals associated with each bead or feature are detected and used as a mechanism to assess the contents of the sample. For additional details describing the implementation these approaches, the reader is referred to the respective product literature and manuals.

The illustrated exemplary scatterplots for the sample data sets 100, 105 reflect exemplary distributions of dual-label signals according to the aforementioned principals wherein signal data from the labeled sample products for a plurality of samples may be evaluated with respect to one another. The x-axis 110 of each scatterplot is associated with the signal intensity detected from a first marker (e.g. first signal intensity) and the y-axis 112 is representative of the signal intensity for a second marker (e.g. second signal intensity). Thus, each data point may be plotted with respect to other data points on the basis of the measured signal intensity values.

Allelic classification of individual samples within the sample set may be performed by evaluating the signal values for the desired sample set with respect to on another. Visualization of the exemplary data via the scatterplot 100 indicates that the data points tend to cluster into groupings 115, 120, 125. These groupings 115, 120, 125 may further be associated with a particular allelic composition or genotype as shown. In one aspect, the first group or cluster 115 may represent those samples having a homozygous allelic composition (e.g. [A/A]); the second group 120 may represent those samples having a heterozygous allelic composition (e.g. [A/B]); and the third group 125 may represent those samples having a homozygous allelic composition (e.g. [B/B]).

The data shown for the first scatterplot 100 may be indicative of samples that have been labeled and detected as described above for a selected number of amplification cycles. The second scatterplot 105 may further represent similar samples that have been subjected to additional rounds of amplification. In comparing the two scatterplots 100, 105 it can be observed that the distribution of signal intensities is not similar between the two sample sets despite having identical compositions. In particular, when comparing each allelic grouping 115, 120, and 125 spectral shifts can be observed wherein the distribution of data points in the scatterplots 100, 105 varies to some degree. Thus, for the allelic grouping 125 corresponding to the [B/B] homozygous allele, a generalized shift in the signal towards the x-axis 110 can be observed when comparing the scatterplots 100, 105. Similarly, the allelic groupings 115, 120 corresponding to the homozygous [A/A] and heterozygous [A/B] alleles respectively also indicate observable shifts in the signal distributions.

Spectral shifting in the aforementioned manner represents one example of how differences may arise even between similar data sets which result in potential difficulties in comparing or evaluating the data. Such differences may also arise from other potential sources of variation and errors as described above creating difficulties in relating and evaluating multiple data sets. Such issues are of concern for example, when applying a selected allele calling method in which the parameters and thresholds may tend to vary significantly from one data set to the next. As a consequence, the criteria for allele identification may be divergent between the data sets and create difficulties in associating the data with a high degree of confidence or accuracy unless the data can be sufficiently normalized scaled or corrected.

As previously indicated, a commonly utilized conventional method for addressing sample to sample deviations incorporates the use of one or more control samples that are present in both data sets and may be used for the purposes of scaling/comparing the data or scatterplots to one another. This approach is not always efficient or desirable however, as a large number of controls may be required with acquired signal intensities that distribute them throughout the experimental data sets or scatterplots. Additionally, regions of the scatterplot that are not represented by a suitable control sample remain subject to undesirable variability's that may be inadequately corrected for using this approach alone.

Control sample correction approaches may also be undesirable from the standpoint that if control samples are used in normalizing/scaling data sets with respect to one another, these controls may no longer be available as experimental success or monitoring indicators. As a consequence, additional controls may be required, undesirably increasing the cost and complexity of the analysis. Furthermore, requisite use of control samples in the aforementioned manner may undesirably constrain the experimental design.

In various embodiments, the present teachings desirably reduce or alleviate the dependence on control samples for purposes of data set normalization, scaling and comparisons. Rather than requiring control information, the information from the data set itself may be utilized by the disclosed normalization methods to provide an improved mechanism for correcting spectral shifts and other variations between data sets. In one aspect, the disclosed data normalization approach is particularly suitable for applications such as array-based analysis alleviating the dependence on control samples for conducting analysis across multiple sample sets.

In one aspect, the data normalization methods of the present teachings involve the development a plurality of correction factors that may be applied to one or more selected data sets to improve the ability to compare and interrelate the information. The correction factors may further be calculated using angular measurements for data points from the sample sets, wherein the angular measurement provides a means by which to numerically associate the relative position of a data point within a scatterplot or allele cluster and may be used to characterize and distinguish data points and allelic clusters from one another.

As shown in the exemplary scatterplot 170 in FIG. 1C each cluster or allelic grouping may be associated with a discrete angular value 175, 180, 185 based on certain characteristics of the selected cluster. For example, the angular value 175 may be determined for the homozygous cluster [A/A] by evaluating the average or mean of the signal intensity ratios for the data points contained within the cluster and associating the resulting value with a selected origin 190 in the scatterplot 173. Likewise, the angular values 180 and 185 may be determined in a similar manner based on the corresponding heterozygous [A/B] and homozygous [B/B] groupings. Similarly, angular values may be determined for each data point, wherein the angular value is determined by assessing the signal intensity ratio for the data point. As will be described in greater detail hereinbelow angular value determination represents a convenient means by which data points of a sample set may be evaluated with respect to one another and these values may be utilized in the normalization methods.

In certain embodiments, other approaches to signal intensity assessment may be utilized in addition to or as a substitute for angular value determination. For example, the signal information for the data points of each sample set may be represented by the log function of the angular value. In still other embodiments, other approaches to representing the signal information of the sample sets may be used and adapted to the normalization methods of the present teachings. Consequently, the methods described herein may be adapted to various manners of representation of the signal information and, as such, differing data representations are conceived to be within the scope and embodiments of the present teachings.

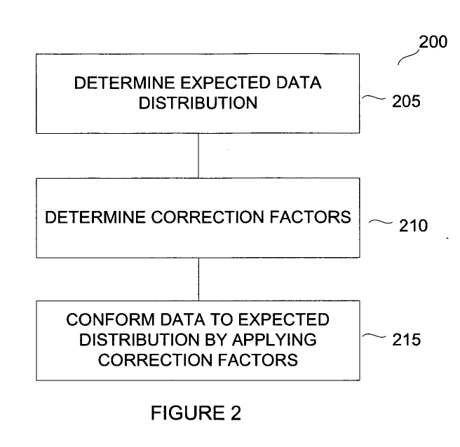

FIG. 2 illustrates an overview of the approach used to account for spectral shifts between samples in a genotyping analysis. In various embodiments, the methods described herein are directed towards the creation of one or more correction factors that may be applied to a selected data set to aid in conforming the data to a desired standard or reference. These methods are particularly suitable for processing SNP genotyping data such as that obtained when working with an array-based data acquisition platform but may also be readily adapted to other high-multiplex assays.

In one aspect, these steps provide a normalization approach 200 that may be used to evaluate information relating to a selected data set which may then be compared to data representative of other data sets. As will be described in greater detail hereinbelow, the approach 200 commences with the determination of an expected data distribution in state 205. In various embodiments, the expected data distribution serves as a “baseline” or “reference” which may be used to assess the quality and conformity of the selected data set and to identify variability's that may affect subsequent comparison of the selected data set with data obtained from other data sets.

Following determination of the expected data distribution, one or more correction factors are calculated for the selected data set in state 210. In various embodiments, the correction factors are determined by assessing the expected data distribution in relation to the data distribution for the selected data set. In one aspect, the correction factors relate the selected data set distribution to the expected data set distribution and account for the variability's between the two.

Once an appropriate set of correction factors for the selected data set has been developed, they may be applied to the selected data set to conform the data to the expected distribution in state 215. In general, application of the correction factors may be readily performed without undo computational overhead and desirably normalizes the data so as to facilitate comparison of discrete or disparate data sets. In various embodiments, such a normalization approach may be desirably utilized to identify and reduce the effects of spectral shifting and variations between data sets.

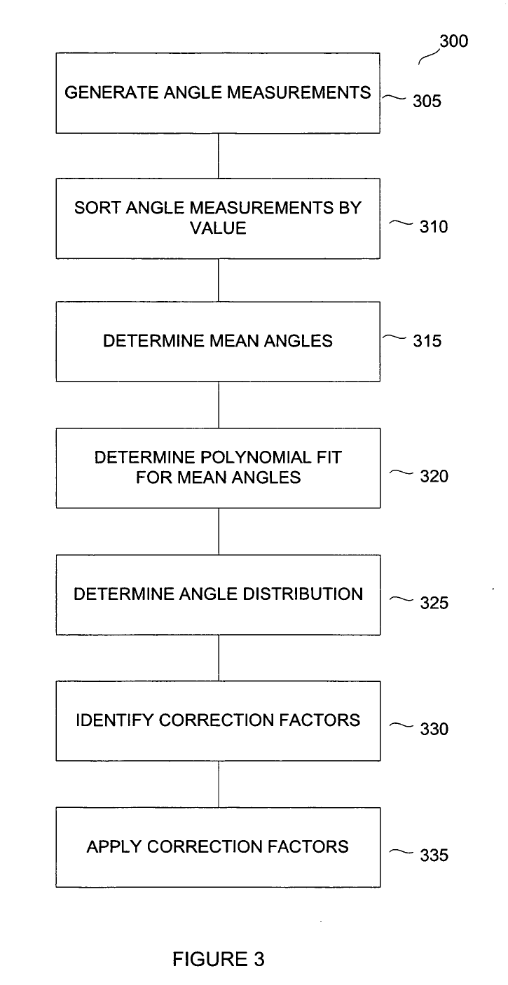

FIG. 3 illustrates details of a method 300 that may be used to generate correction factors to account for spectral shift between arrays during SNP analysis. Using this approach, data and information provided by a plurality of data sets (e.g. or multiplex data) may be quickly and conveniently normalized such that the undesirable effects resultant from spectral shifts and variations may be reduced. The resulting application of the correction factors determined according to this method 300 may be used to improve the quality of analysis and reduce inconsistencies arising from deviations in the data between the data sets.

In one aspect, the data and information associated with each array used in the SNP analysis comprises a plurality of angular measurements indicative of the relative observed signal intensities for labels or markers associated with one or more SNPs for one or more samples. Each sample typically comprises a plurality non-SNP nucleotides along with one or more SNP nucleotides whose sequence may vary. As described above, the composition of SNP nucleotides for a selected sample may be used to characterize the allelic composition of the sample as homozygous or heterozygous as previously indicated.

In the description of the method below, angular measurements provide a convenient means for associating the data between arrays and generating correction factors that may be used to adjust the angular measurements of each array so that the data arising therefrom may be normalized with respect to other arrays. It will be appreciated by one of skill in the art, that angular measurement determination is but one manner in which to assess and compare array-based data and other approaches to data representation may be readily adapted to operate with the present teachings. Consequently, other manners of data representation adapted for use with the methods described herein are considered to be but other embodiments of the present teachings.

Referring again to FIG. 3, the data correction/normalization method 300 commences in state 305 wherein angle measurements are generated. In one aspect, these angle measurements are derived from the signal intensity information of each data set and may be representative of a plurality of SNPs for a plurality of discrete sample species (e.g. DNA, RNA, gene, allele, etc). Various methods for determining angle measurements are known in the art and such information may be obtained from data acquisition/software applications associated with an array analysis instrument.

As previously indicated each sample species is generally associated with a plurality of SNPs and corresponding angle measurements are sorted in state 310. In one aspect, for each sample species, the associated angle measurements are sorted by value from low to high to generate an ordered set of angle measurements. SNP angle ordering in this manner may further be used to organize the sample species on the basis of angle measurements for those SNPs associated with each sample species. Thus, the sample species can be arranged or grouped according to their constituent SNP angle measurements.

Subsequently, in state 315 a mean angle determination is performed wherein selected ranges of angle measurements are identified and those sample species containing SNPs having angle measurements falling within the selected range are collected and a mean angle determined. In one aspect, mean angle determination proceeds sequentially wherein the mean angle is calculated for the lowest angle (or angular range) for all sample species. Subsequently, the mean angle is calculated for the second lowest angle (or angular range), and so on, repeating the process through the highest angle (or angular range).

In one aspect, the resulting mean angle determinations provide the basis for a subsequent series of calculations in state 320. In this state, the mean angle values are evaluated against a calculated percentile of occurrence for that angle in the complete angular distribution. In one aspect, a curve fitting approach may be used such as performing a least squares polynomial fit for a selected mean angle vs. the percentile of that angle in the complete angular distribution. In general, the order of the polynomial may depend on the number or quantity of data points present in the data set and may be first order, second order, third order, fourth order, and so on. Applying the aforementioned curve fitting approach to the percentile indices for the angular values provides a mechanism to assess the expected average distribution and may be useful in associating data acquired from different arrays or experiments.

In state 325, an expected distribution of angles is determined for a selected sample species associated with a particular array or experiment. In one aspect, the expected distribution of angles may be determined by forming subsets of data points according to selected percentile groupings. For example, subsets of data points may be identified by taking evenly spaced percentiles from 0 to 100% having approximately the same number of data points as there are angles for a selected sample species. Subsequently, an expected angle associated with the data subset may be calculated using the polynomial values obtained in the previous state 320.

In state 330, a least squares polynomial fit for the sorted angles of a selected sample species versus the expected values derived in the previous state 325 is determined. As before, the order of the polynomial will generally depend on the number of data points and may vary from one analysis to the next. The coefficients of the polynomial determined in this state 330 are representative of “correction factors” for a selected array, data set, or experiment and these correction factors may be applied to the angular measurements for a selected sample species in state 335. In various embodiments, application of the correction factors to the angular measurements provides a mechanism to adjust the distribution of angles for a selected array to match an expected distribution as determined in state 320.

In one embodiment, the aforementioned methods may be used for the analysis of data sets which comprise a substantially normal pattern of distribution. For example, SNP or genotype data typically displays a normal distribution between homozygotes and heterozygotes. In another embodiment, the normal distribution may be represented by a substantially bell-shaped curve. This curve may further be skewed (e.g. to the right or left) in certain cases. In a further embodiment, the normal distribution may have a mean of approximately 0 and a standard deviation of approximately 1. In a still further embodiment, the method may be used for assays or arrays which have a sufficient number of data points to produce substantially any distribution.

In other embodiments, the disclosed methods may be used for those data sets or assays which are multiplexed by approximately 100 fold or more. In further embodiments, the method may be used for those assays which are multiplexed at least 200 fold, 300 fold, 400 fold or more. In these contexts, multiplexing may be defined to be defined in a manner that there are at least “X” different answers or possible outcomes for each assay where “X” is representative of the fold value. Alternatively, multiplexed can mean that there will be at lease “X” different data points to analyze per assay where “X” is representative of the fold value.

In various embodiments, the method described in conjunction with FIG. 3 above may be modified somewhat according to the preferences of the investigator. For example, rather than performing the operations leading to the determination of polynomial fit for the calculated mean angles to establish the distribution, another mechanism for distribution determination may be selected as a substitute. For example, in various embodiments, a distribution range or threshold set may be determined by identifying substantially evenly spaced increments between 0 and 90 degrees. For example, the distribution increments may comprise the ranges 0-25 degrees, 25-50 degrees, 50-75 degrees, and 75-90 degrees. Additionally, other evenly and non-evenly spaced increments may be used. For the selected distribution range(s), the sample species may conform to selected range(s) and criteria's to allow proper evaluation and normalization against other sample species or data distributions.

Another potential modification to the methods described above may be to omit polynomial fitting and assign spaced angular values to the sorted list of angles. For example, evenly spaced values between −2 and 2 may be selected and assigned to the sorted list of angles from each data set without a requisite polynomial fitting operation. Distribution determination and correction factor calculation may then proceed in an analogous manner as before.

Each of the disclosed alternative approaches to correction factor determination provides a useful mechanism that may be used in connection with data normalization as described herein especially when it is desirable to reduce or minimize computational overhead. In various embodiments, computational performance may be enhanced by applying one of the alternative approaches with little or no loss in accuracy.

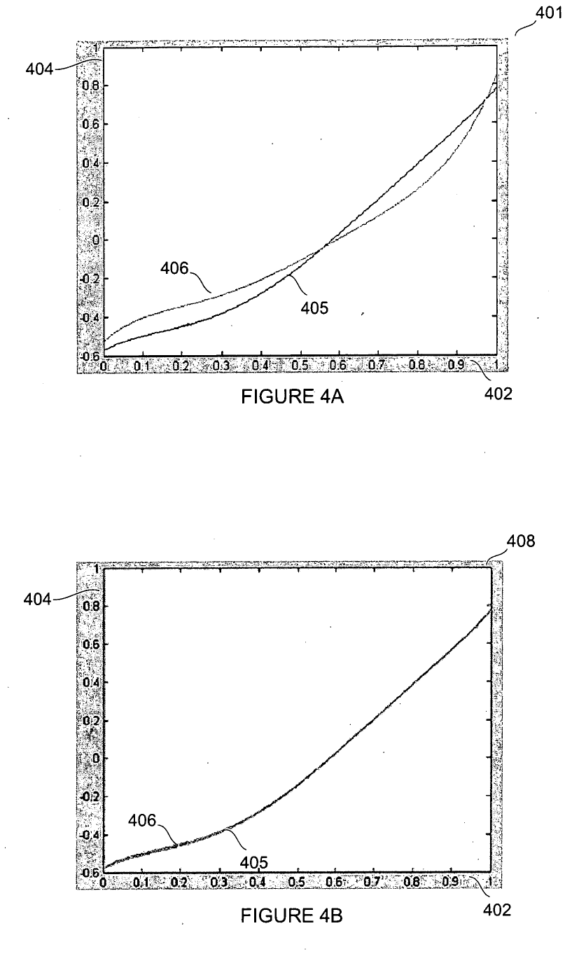

FIGS. 4 A-B graphically illustrate how data from the selected data set may be compared to data representing the average/composite data set (e.g. an array or bundle set) wherein the data is plotted on a graph as a log ratio versus percentile for a single data set as compared to an averaging for a plurality of data sets. In the graph shown in FIG. 4A, the x-axis 402 represents the percentile (0-1) of the log ratio for all SNPs represented in a single data set and the y-axis 404 represents the log ratio at various selected percentile values for the data set. While the data illustrated in this graph 401 uses log ratios as a standard for comparison of information across arrays it will be appreciated that angular values may also be utilized in a similar manner.

In one aspect, a composite data distribution 405 represents a normal distribution of sorted data for a plurality of data set. More specifically, in this example, the composite data distribution 405 represents the normal distribution for approximately 130 discrete data sets. The sample data distribution 406 represents information from an exemplary data set wherein the data has been affected by spectral shifting or other data variations. When comparing the two data distributions 405, 406 observable differences can be noted. In particular, throughout the sample data distribution 406 significant variations may be observed as compared to the composite data distribution. These variations may undesirably affect the nature of SNP identification and reduce call confidence and/or accuracy as will be appreciated by one of skill in the art.

In one aspect, the method of data normalization of the present teachings may be applied to the sample data distribution 406 so as to develop appropriate correction factors that may be used to alter the sample data distribution 406 in such a way so as to conform it to the composite data distribution 405. As shown in FIG. 4B representing a normalized graph 408, when these correction factors are applied to the data of the selected data set, the variations between the two data distributions 405, 406 may be significantly reduced. Graphically, reduction of data distribution variability may be visualized as a “merging” of the sample data distribution 406 with the composite data distribution 405 wherein differences between the data sets 405, 406 are markedly reduced. One desirable benefit of this normalization procedure is that data from different data sets (e.g. arrays or experiments) may be more readily compared with improved accuracy and confidence. Furthermore, lacking the requisite use of control samples or information in performing the normalization procedure reduces the degrees of freedom which must be consumed in comparing data from one array to the next thereby increasing the flexibility of the analysis. In one aspect, control samples and information may therefore be preserved to independently verify the correctness or accuracy of the correction factors improving the confidence in the assay performance.

This above described method may be used in connection with a wide variety or different types of sample identification technologies, including but not limited to: DNA, RNA, oligonucleotide, peptide, protein, chemical, pharmaceutical, antibody, SNP genotyping, infectious disease diagnosis, high throughput protein and gene analysis, phamacogenetics, paternity and forensics testing. In various embodiments, use of the methods described herein desirably enables more SNPs to be utilized in a high-multiplex SNP genotyping system and improves the confidence an individual may have in the assay performance since the controls can be used to independently verify the correctness of the correction factors.

One class of technology to which these methods may be applied includes microarrays or oligonucleotide arrays. Typical arrays utilize a large number of probes that may be synthesized on or secured to (e.g. spotted or printed) a substrate and may be used to interrogate complex nucleotide populations based on the principle of complementary hybridization. Data normalization in this context generally necessitates the use of integrated conventional controls present within each array. However, using the disclosed methods such controls may be retained for assay performance analysis and need not be required in data normalization across multiple arrays.

In addition there exist other platform types and configurations which may also be adapted to operate in conjunction with and benefit from the normalization methods of the present teachings. Exemplary platforms include, but are not limited to: protein detection platforms, antibody detection platforms, expression detection platforms, forensics/paternity testing platforms, disease-specific detection platforms, pharmacogenetic analysis platforms, and pharmaceutical analysis platforms.

For example, certain protein analysis platforms allow the simultaneous analysis of thousands of parameters within a single experiment. Additionally, microspots of capture molecules may be immobilized in rows and columns onto a solid support and exposed to samples containing the corresponding binding molecules. Detection systems based on fluorescence, chemiluminescence, radioactivity and electrochemistry may be used to detect complex formation within each microspot. Recent developments in the field of protein analysis platforms show applications for enzyme-substrate, DNA-protein and different types of protein-protein interactions.

In addition to the aforementioned technologies and applications which may be adapted for use with the methods of the present teachings, other technologies and platforms which may benefit from global distribution assessment in data normalization include OLA protocols, PCR protocols, purification protocols, hybridization protocols, matrix analysis protocols, and SNP analysis protocols. The disclosed methods may also be used in combination with a variety of different data analysis instrumentation types. In one implementation, the present teachings are used in conjunction with an nucleic acid analyzers and integrated into the associated analysis software to provide a means for assessing discrete samples or data sets. Alternatively, the disclosed methods may be provided as a separate software product in which data generated by a selected instrument is imported into the software application for processing and review.

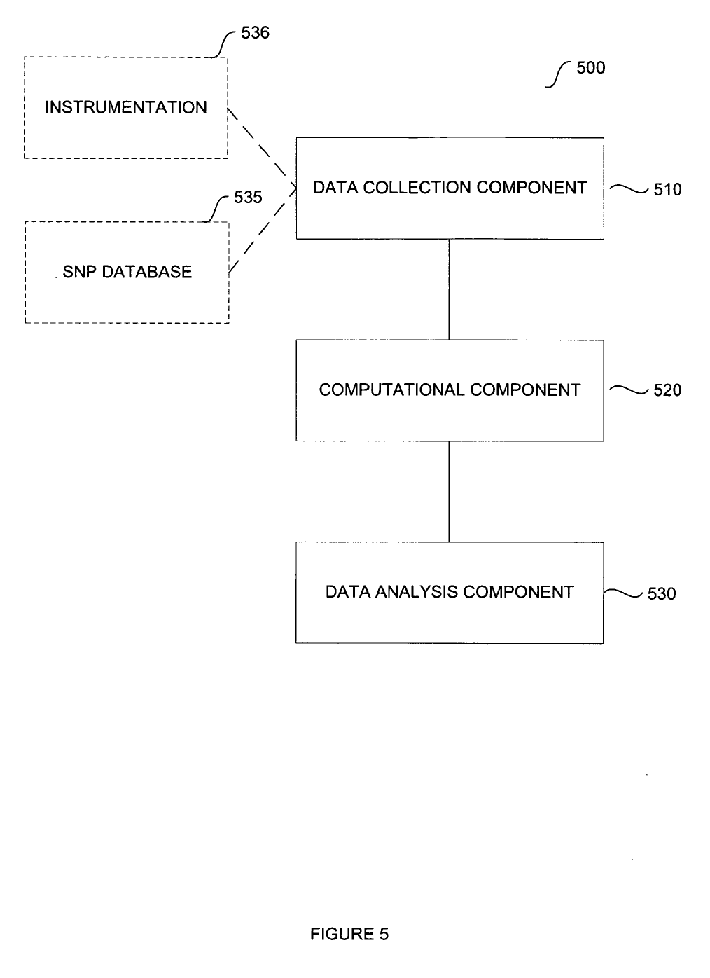

FIG. 5 illustrates a block diagram of an exemplary system 500 for conducting data analysis according to the present teachings. In one aspect, the system 500 comprises components/modules including; a data collection component 510, a computational component 520, and a data analysis component 530.

In accordance with the methods described above, the data collection component 510 may be configured to provide functionality for collecting, selecting, and/or providing a collection of data comprising analysis information associated with a plurality of data points such as those that may be associated with allele-identification analysis or single nucleotide polymorphism (SNP) analysis. This information may be obtained from a database or datastore 535 containing the desired analysis or experimental information to be normalized. Alternatively, this information may be provided directly or indirectly by instrumentation 536 used in data acquisition. The data collection component 510 may further comprise a software component that interacts with various hardware or other software components and provides functionality for issuing commands/instructions that effectuate the transmission/collection of the analysis information. The data collection component 510 may further perform various preprocessing steps to prepare the data collection for subsequent normalization by the computational component 520.

The computational component 520 provides functionality for normalizing the data collection implementing the methods as described above. In one aspect, the computational component 520 may be configured with functionality for performing the normalization operations associated with determining the correction factors wherein a selected distribution is used to fit the data collection. The selected distribution may be configured, for example, as an evenly spaced distribution between approximately 0 and 90 degrees. Additionally, the computational component may determine an expected distribution that is applied to substantially each data point or member of the data collection. In one aspect, the computational component 520 may be configured such that it sorts, classifies, and/or categorizes the data collection into substantially even distributions of a desired quantity or amount. For example, the computational component 520 may assign substantially evenly spaced values between approximately −2 and 2 to the sorted data collection represented by a plurality of angular values without polynomial fitting. Upon conducting the desired operations, the computational component 520 may determine/calculate the correction factors as described above which may then be transmitted or utilized by the data analysis component 530.

The data analysis component 530 provides functionality for applying the correction factors to the data collection. As previously described, application of the correction factors to the data collection provides a mechanism by which to conform the data collection to the expected distribution. Thereafter, the data analysis component 530 may perform additional desired analytical operations or make the processed data available to other components for further analysis. In one aspect, the data analysis component 530 may further provide functionality for viewing aspects of the data collection such as reviewing selected data before and after application of the data normalization operations. This functionality may include preparing selected graphical or pictorial representations of the data or allow viewing of numerical or other information associated with the data collection. The above-described functionality may further operate on a portion or substantially all of the data as desired.

While the principal operations of the exemplary system 500 are described above, it will be appreciated that various modifications and additional functionalities may reside within the system 500 without departing from the scope of the present teachings. Additionally, while the components 510, 520, 530 of the system 500 are discretely represented it will be appreciated that the components 510, 520, 530 may be implemented separately, combined or representative of a various combinations of functionality provided by a singular or multicomponent component or module.

It will be appreciated that high multiplex SNP analysis or array-based analytical platforms may generate or operate in connection with many data points associated with one or more data sets representative of one or more samples (e.g. DNA, RNA, peptide, protein, etc). Analysis across collections of data representative of 2 or more samples, data sets, arrays, and/or experiments may result in deviations in the observed spectrum or distribution of the data. These deviations may be expressed as described above for example as the angle of a plot of signal for a first label (e.g. wavelength A) over a signal for a second label (e.g. wavelength B). Evaluating the data (for example, using a standard deviation analysis) may indicate that at least a portion of the data (e.g. cluster) is increased due to various variabilities for example, array-to-array variabilities, experiment-to-experiment variabilities, etc. These variabilities may affect the signal properties (e.g. spectral properties) of the data making it desirable to provide a mechanism by which to correct for the variabilities and improve that ability for an investigator to analysis the data collectively.

In accordance with the present teachings, addressing these variabilities may be accomplished by application of the disclosed approaches. In one aspect, a method, system, and/or software application may be configured by application of an approach in which: Angle measurements are generated as described above across two or more samples, data sets, etc. In one aspect, the two or more samples may be representative of multiple SNPs associated with multiple samples. The angle measurements for the multiple SNPs associated with a selected sample are sorted (for example from lowest to highest) and the process repeated for each remaining sample. Thereafter, a mean angle for the lowest angle SNP for all samples may be determined with this process repeated for the second lowest, etc, up to the highest angle.

Subsequently, a least squares polynomial fit for the mean angle versus the percentile of that angle in relation to substantially all of the mean angles may be determined. In one aspect, the order of the polynomial depends on the number of data points within the data collection and the polynomial fit provides a representation of an expected average distribution. From this determination, an expected distribution of angles from the number of data points associated with one sample may be evaluated, for example by taking a substantially evenly spaced list of percentiles from 0 to 100% with substantially the same number of data points as there are angles for the selected sample and calculating the expected angle from the previously determined polynomial values.

For each sample, a least squares polynomial fit may then be determined for the sorted angles of this sample versus the expected values described above. The coefficients of this polynomial fit may be considered as representative of correction factors for a selected sample (e.g. array). Applying these correction factors for each angle measurement associated with the selected sample may be used to conform the distribution of angles associated with the sample to the previously determined expected distribution.

The follow examples provide details of selected experiments conducted to assess several adaptations of the methods for use in various contexts. It will be appreciated that these examples are provided for illustrative purposes only and should not to be construed as limiting upon the present teachings.

The first example illustrates the use of the normalization method in conjunction with a relatively small sample data set. The second example provides the results of another adaptation of the normalization methods. The third example illustrates the relatively high accuracy obtained by using a selected adaptation of the method described herein.

### EXAMPLE 1

Example 1 represents the results obtained for a relatively small data set comprising 5 different SNPs in 6 samples. Fluorescence intensities between the two alleles for each SNP were determined. The fluorescence intensities were graphed such that one allele was represented on the x-axis and the second allele was represented on the y-axis. From this information, the polar angle was determined. These operations were performed for each SNP in each sample (see Table 1).

TABLE 1
Sample Data:

| | Sample | Sample | Sample | Sample | Sample | Sample |
|---|---|---|---|---|---|---|
| Angles | 1 | 2 | 3 | 4 | 5 | 6 |
| SNP 1 | 10 | 85 | 15 | 40 | 45 | 80 |
| SNP 2 | 1 | 2 | 20 | 3 | 24 | 60 |
| SNP 3 | 11 | 1 | 5 | 6 | 40 | 45 |
| SNP 4 | 90 | 3 | 43 | 86 | 5 | 10 |
| SNP 5 | 88 | 47 | 45 | 70 | 73 | 85 |

Using the aforementioned ranking approach each data point was ranked according to fluorescence intensity within its respective sample as shown in Table 2. In this case, the data point was ranked from lowest to highest angle. However, ranking could have similarly proceeded from highest to lowest. In general, the method of ranking will be similar for each sample.

TABLE 2
Exemplary Ranking of Sample Data:

| | Sample | Sample | Sample | Sample | Sample | Sample |
|---|---|---|---|---|---|---|
| Rankings | 1 | 2 | 3 | 4 | 5 | 6 |
| SNP 1 | 2 | 5 | 2 | 3 | 4 | 4 |
| SNP 2 | 1 | 2 | 3 | 1 | 2 | 3 |
| SNP 3 | 3 | 1 | 1 | 2 | 3 | 2 |
| SNP 4 | 5 | 3 | 4 | 5 | 1 | 1 |
| SNP 5 | 4 | 4 | 5 | 4 | 5 | 5 |

After ranking the SNPs within each sample, the rank was converted to a percentile range or threshold within each sample for each data point as shown in Table 3. For example, in Sample 1, the “1” ranking was converted to 0% range, the “2” rating was converted to 25% range, etc. The manner in which ranges or thresholds are designated or the process by which the conversion is conducted is flexible with the general aim to maintain uniformity between the relationships. In this way the data was corrected for array to array variability and the results allow comparison from one sample to the next.

TABLE 3
Example percentiles

| | Sample | Sample | Sample | Sample | Sample | Sample |
|---|---|---|---|---|---|---|
| Percentiles | 1 | 2 | 3 | 4 | 5 | 6 |
| SNP 1 | 25% | 100% | 25% | 50% | 75% | 75% |
| SNP 2 | 0% | 25% | 50% | 0% | 25% | 50% |
| SNP 3 | 50% | 0% | 0% | 25% | 50% | 25% |
| SNP 4 | 100% | 50% | 75% | 100% | 0% | 0% |
| SNP 5 | 75% | 75% | 100% | 75% | 100% | 100% |

### EXAMPLE 2

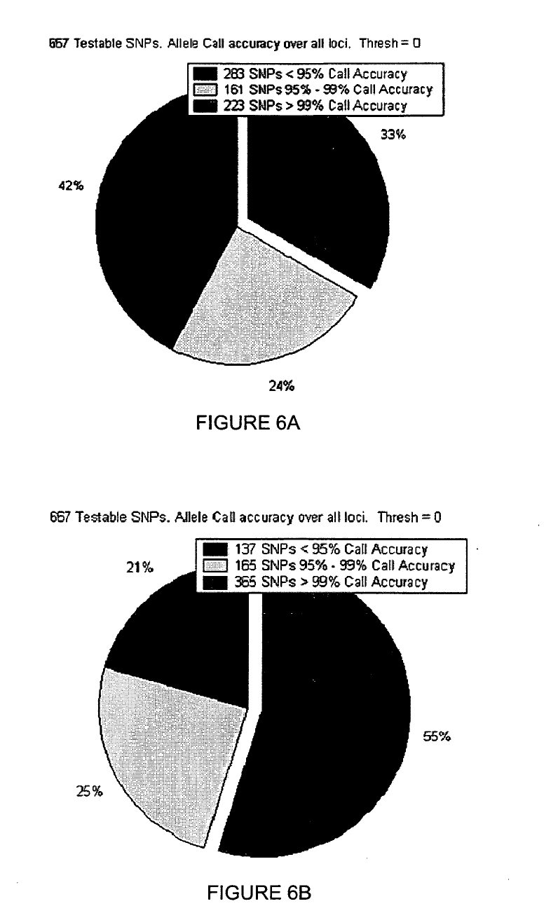

Example 2 represents the results obtained for a larger data set wherein a SNP analysis was performed using fluorescence data obtained from 667 detectable SNPs. Using this information, an approximated accuracy assessment was determined before and after correction using the correction factor determination method described in connection with FIG. 3. Using this method, known SNPs were tested for call accuracy and the results plotted as a pie chart (see FIGS. 6A and 6B).

When evaluating the call accuracy over all loci for the selected set of SNPs without applying the correction factors, it was determined that approximately 42% of the SNPs (e.g. 283 SNPs) displayed a call accuracy below 95%. Of the remaining SNPs, 24% (e.g. 161 SNPs) demonstrated a call accuracy between 95%-99% and 33% (e.g. 223 SNPs) demonstrated a call accuracy greater than 99%.

However, after calculation and application of the correction factors as described by the present teachings a significant increase in call accuracy was observed. As shown in FIG. 6B, for the same data set with the correction factors applied, those SNPs demonstrating a call accuracy greater than 99% increased to 55% (e.g. 365 SNPs). Likewise, an increase in the number of SNPs displaying a call accuracy between 95%-99% was observed (e.g. 165 SNPs). Taken together, these improvements resulted in a significant decrease in the number of SNPs having a call accuracy below 95% (e.g. 137 SNPs).

The preceding exemplary data indicates that a marked improvement in call accuracy was observed when applying the normalization approach of the present teachings with the greatest improvement noted for SNPs having a very high call accuracy threshold (e.g. greater than 99%). As demonstrated by this exemplary data the present teachings therefore provide a straightforward approach to realizing substantial improvements in call accuracy during SNP and genotyping analysis. Implementation of these methods further does not typically incur a large computational overhead to the data analysis flow and may be readily implemented in a number of different contexts.

The various methods and techniques described above provide a number of examples of how the present teachings may be implemented and the potential benefits realized when applying them. It is to be understood that not necessarily all objectives or advantages described may be achieved in accordance with any particular embodiment described herein. Thus, for example, those skilled in the art will recognize that the methods may be performed in a manner that achieves or optimizes one advantage or group of advantages as taught herein without necessarily achieving other objectives or advantages as may be taught or suggested herein.

Furthermore, the skilled artisan will recognize the interchangeability of various features from different embodiments. Similarly, the various features and steps discussed above, as well as other known equivalents for each such feature or step, can be mixed and matched by one of ordinary skill in this art to perform methods in accordance with principles described herein.

Although the invention has been disclosed in the context of certain embodiments and examples, it will be understood by those skilled in the art that the invention extends beyond the specifically disclosed embodiments to other alternative embodiments and/or uses and obvious modifications and equivalents thereof. Accordingly, the invention is not intended to be limited by the specific disclosures of preferred embodiments herein, but instead by reference to claims attached hereto.

What is claimed is:

1. A method for evaluating information during biological analysis, the method comprising:
identifying a data collection comprising a plurality of signal values associated with at least one sample;
providing a common representation of the signal values and determining a sorting criteria that is applied to the common representation of the signal values;
determining an expected distribution of the signal values; and
determining at least one correction factor applied to at least one of the plurality of signal values so as to conform the at least one signal value to the expected distribution.

2. The method of claim 1 wherein, application of the at least one correction factor provides a mechanism to compensate for systematic deviations associated with the plurality of signal values.

3. The method of claim 2 wherein, the systematic deviations comprise variabilities selected from the group consisting of: platform variabilities, sample variabilities, and instrument variabilities.

4. The method of claim 1 wherein, the common representation of signal values comprises determining an angular representation of each signal value and the sorting criteria that is applied to the signal values is based at least in part upon the angular representation.

5. The method of claim 4 wherein, the sorting criteria that is applied to the signal values comprises sorting the angular representations of signal values associated with each sample on the basis of magnitude.

6. The method of claim 1 wherein, determining the expected distribution of signal values comprises performing at least one polynomial fitting operation using the common representation of the signal values wherein coefficients of the polynomial fitting operation provide the at least one correction factor.

7. The method of claim 1 wherein, application of the at least one correction factor provides a mechanism to compensate for data set variabilities selected from the group consisting of: instrument movements, optical alignment variabilities, focus variabilities, sample cross-hybridization, non-specific binding, amplification bias, label incorporation bias, label degradation, and presence of impurities.

8. The method of claim 1 wherein, the data collection comprises signal information generated by a label selected from the group consisting of: fluorescent labels, radioactive labels, and chemiluminescent labels.

9. The method of claim 1 wherein, the data collection is used in biological analysis selected from the group consisting of: genotyping analysis, single nucleotide polymorphism analysis, haplotyping analysis, allelic analysis, mutational analysis, nucleotide analysis, protein analysis, peptide analysis, and disease analysis.

10. A system for evaluating information during biological analysis, the system comprising:
a data collection component the provides functionality for identifying a data collection comprising a plurality of signal values associated with at least one sample;
a computational component that provides functionality for generating a common representation of the signal values, determining a sorting criteria that is applied to the common representation of the signal values and determining an expected distribution of the signal values; and
an analysis component that provided functionality for determining at least one correction factor applied to at least one of the plurality of signal values so as to conform the at least one signal value to the expected distribution.

11. The system of claim 10 wherein, the common representation of signal values provided by the computational component is determined as an angular representation of each signal value and the sorting criteria that is applied to the signal values is based at least in part upon the angular representation.

12. The system of claim 11 wherein, the sorting criteria that is applied to the signal values comprises sorting the angular representations of signal values associated with each sample on the basis of magnitude.

13. The system of claim 10 wherein, the expected distribution of signal values determined by the computational component is performed through at least one polynomial fitting operation using the common representation of the signal values wherein coefficients of the polynomial fitting operation provide the at least one correction factor.

14. The system of claim 10 wherein, application of the at least one correction factor by the analysis component provides a mechanism to compensate for data set variabilities selected from the group consisting of: instrument movements, optical alignment variabilities, focus variabilities, sample cross-hybridization, non-specific binding, amplification bias, label incorporation bias, label degradation, and presence of impurities.

15. The system of claim 10 wherein, the data collection comprises signal information generated by a label selected from the group consisting of: fluorescent labels, radioactive labels, and chemiluminescent labels.

16. The system of claim 10 wherein, the data collection is used in biological analysis selected from the group consisting of: genotyping analysis, single nucleotide polymorphism analysis, haplotyping analysis, allelic analysis, mutational analysis, nucleotide analysis, protein analysis, peptide analysis, and disease analysis.

17. An apparatus comprising a computer readable medium having instructions stored thereon to analyze nucleotide sequence information by the steps of:
identifying a data collection comprising a plurality of signal values associated with at least one sample;
providing a common representation of the signal values and determining a sorting criteria that is applied to the common representation of the signal values;
determining an expected distribution of the signal values; and
determining at least one correction factor applied to at least one of the plurality of signal values so as to conform the at least one signal value to the expected distribution.

18. The apparatus of claim 17 wherein, the data collection comprises signal information generated by a label selected from the group consisting of: fluorescent labels, radioactive labels, and chemiluminescent labels.

19. The apparatus of claim 17 wherein, the data collection is used in biological analysis selected from the group consisting of: genotyping analysis, single nucleotide polymorphism analysis, haplotyping analysis, allelic analysis, mutational analysis, nucleotide analysis, protein analysis, peptide analysis, and disease analysis.

20. A method for genetic analysis, the method comprising:
identifying a sample set comprising a plurality of signal values associated with a plurality of sample species;
generating angular measurements corresponding to the plurality of signal values for the sample set;
sorting the angular measurements for each of the sample species;
calculating a mean angle for the sorted angular measurements for each of the sample species;
determining a polynomial fit for each mean angle versus a calculated percentile for that mean angle in relation to mean angles for other sample species of the sample set;
calculating an expected angular distribution for the plurality of signal values associated with a selected sample species;
calculating a polynomial fit for the sorted angular measurements for the selected sample species versus the expected angular distribution to identify at least one correction factor for the angular measurements; and
applying the correction factor to the angular measurements associated with a selected sample species to conform the distribution of angles to the expected distribution.

21. The method of claim 20 wherein, the sample set is used in biological analysis selected from the group consisting of: genotyping analysis, single nucleotide polymorphism analysis, haplotyping analysis, allelic analysis, mutational analysis, nucleotide analysis, protein analysis, peptide analysis, and disease analysis.

22. The method of claim 20 wherein, the expected distribution of angular measurements is determined by evaluating an evenly spaced list of percentiles and calculating the expected angular measurement using the polynomial fit for each mean angular measurement.

23. The method of claim 20 wherein, the sample set comprises signal information generated by a label selected from the group consisting of: fluorescent labels, radioactive labels, and chemiluminescent labels.
